(19) United States
(12) Patent Application Publication
(10) Pub. No.: US 2005/0238947 A1
(43) Pub. Date: Oct. 27, 2005

(54) Membrane-electrode assembly for fuel cell and fuel cell system including the same

(76) Inventor: Kyu-Woong Cho, Suwon-si (KR)

Correspondence Address: MCGUIREWOODS, LLP, 1750 TYSONS BLVD, SUITE 1800, MCLEAN, VA, 22102, US

(21) Appl. No.: 11/110,866

(22) Filed: Apr. 21, 2005

(30) Foreign Application Priority Data
Apr. 22, 2004 (KR) 10-2004-0027835

(51) Int. Cl. H01M 4/92; H01M 8/10

(52) U.S. Cl. 429/40; 429/30

(57) ABSTRACT

The present invention provides a membrane-electrode assembly for a fuel cell, and a fuel cell system that includes the same. The membrane-electrode assembly includes catalytic layers that are coated on both sides of a polymer electrolyte membrane. The catalytic layers include an alloy catalyst made of platinum and transition metals, and the D-band vacancy of the 5d-band orbital of the platinum is in the range of 0.3 and 0.45. The catalyst has excellent mass activity which improves the function of the fuel cell.

### CROSS REFERENCE TO RELATED APPLICATION

This application claims priority to and benefit of Korean patent application No. 10-2004-0027835 filed in the Korean Intellectual Property Office on Apr. 22, 2004, which is hereby incorporated by reference for all purposes as if fully set forth herein.

### BACKGROUND OF THE INVENTION

1. Field of the Invention

The present invention relates to a membrane-electrode assembly for a fuel cell, and a fuel cell system including the same. In particular, the present invention relates to a membrane-electrode assembly for a fuel cell that includes a catalyst with excellent catalytic activity and a fuel cell system including the same.

2. Description of the Background

Generally, a fuel cell is a battery that is capable of producing electric current by directly converting chemical energy into electric energy. It is an electric power generating system that converts energy produced by reacting fuel such as hydrogen or methanol with an oxidizer such as oxygen or air into electric energy.

Such a fuel cell is externally supplied with fuel and continuously produces an electric current without charging and discharging cycles. This type of a fuel cell is not under the control of thermodynamic efficiency and therefore, it has very high efficiency compared with an electric generator that uses mechanical energy or heat energy by fuel combustion.

Commonly used fuel cells include a polymer electrolyte membrane fuel cell (PEMFC) and a phosphoric acid fuel cell (PAFC) that both use an acid electrolyte. The chemical reactions in the fuel cells using the acid electrolyte are as follows:
Cathode reaction: O₂+4H⁺+4e⁻→2H₂O
Anode reaction: H₂→2H⁺+2e⁻
Total reaction: 2H₂+O₂→2H₂O

As shown above, a fuel, generally hydrogen, is supplied to the anode and simultaneously an oxidizer, generally air, is supplied to the cathode to produce energy by oxidization of the fuel in the anode. The chemical reaction also produces water as a byproduct when reacting hydrogen with oxygen. At that time, electrons to be used in the oxygen reduction reaction on the cathode are produced by a catalyst.

To improve the efficiency of a fuel cell, catalyst efficiency is an important factor. Platinum and other noble metals, which are the most stable in chemical reactions, have been used as catalysts. However, since platinum is expensive, it is not feasible to use it as a catalyst in commercial fuel cells.

Therefore, research in the use of alloyed metal catalysts instead of noble metals such as platinum has been undertaken. For example, U.S. Pat. No. 4,447,506 discloses alloy catalysts such as Pt—Cr—Co, Pt—Cr, etc., and U.S. Pat. No. 4,822,699 discloses alloy catalysts such as Pt—Ga, Pt—Cr, etc.

However, the activity of such alloy catalysts is lower than the activity of platinum catalysts. Thus, research related to a catalyst other than a noble metal that is also capable of improving the efficiency of a fuel cell is ongoing.

### SUMMARY OF THE INVENTION

The present invention provides a membrane-electrode assembly for a fuel cell that includes a catalyst that is economical and has excellent catalytic activity that can solve the foregoing problems.

The present invention also provides a fuel cell that includes the membrane-electrode assembly.

Additional features of the invention will be set forth in the description which follows, and in part will be apparent from the description, or may be learned by practice of the invention.

The present invention discloses a membrane-electrode assembly for a fuel cell that comprises catalytic layers that are arranged on both sides of a polymer electrolyte membrane. The catalytic layers include a platinum and transition metals alloy catalyst that has a D-band vacancy in the 5d-band orbital of platinum that is between 0.3 and 0.45.

The present invention also discloses a fuel cell system that includes one or more unit cells including a polymer electrolyte membrane, a membrane-electrode assembly including a cathode electrode and an anode electrode that are coated with catalytic layers arranged on both sides of the polymer electrolyte membrane, and separators for holding the membrane-electrode assembly therebetween. The catalytic layers include an alloy catalyst made of platinum and transition metals, with a D-band vacancy of the 5d-band orbital of the platinum that is between 0.3 and 0.45.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are incorporated in and constitute a part of the specification, illustrate embodiments of the invention, and together with the description, serve to explain the principles of the invention.

FIG. 1 is a graph showing a D-band vacancy and mass activity of the 5d-band orbital of platinum with regard to a catalyst for a fuel cell in Examples 1 to 3 and Comparative Example 1.

FIG. 2 is a graph showing absorption results in the L₂ edge with regard to measurements of a catalyst for a fuel cell in Examples 1 to 3 and Comparative Example 1 with XAS.

FIG. 3 is a graph showing absorption results in the L₃ edge with regard to measurements of a catalyst for a fuel cell in Examples 1 to 3 and Comparative Example 1 with XAS.

FIG. 4 is a graph showing absorption results in the L₂ edge with regard to measurements of a catalyst for a fuel cell in Examples 4 to 6 and Comparative Example 1 with XAS.

FIG. 5 is a graph showing absorption results in the L₃ edge with regard to measurements of a catalyst for a fuel cell in Examples 4 to 6 and Comparative Example 1 with XAS.

FIG. 6 is a graph showing absorption results in the L₂ edge with regard to measurements of a catalyst for a fuel cell in Example 7 with XAS.

FIG. 7 is a graph showing absorption results in the L₃ edge with regard to measurements of a catalyst for a fuel cell in Example 7 with XAS.

FIG. 8 is a graph showing absorption results in the L₂ edge with regard to measurements of a catalyst for a fuel cell in Example 8 with XAS.

FIG. 9 is a graph showing absorption results in the L₃ edge with regard to measurements of a catalyst for a fuel cell in Example 8 with XAS.

FIG. 10 is a graph showing absorption results in the L₂ edge with regard to measurements of a catalyst for a fuel cell in Example 9 with XAS.

FIG. 11 is a graph showing absorption results in the L₃ edge with regard to measurements of a catalyst for a fuel cell in Example 9 with XAS.

FIG. 12 is a schematic view showing a fuel cell system according to an embodiment of the present invention.

FIG. 13 is an exploded perspective view showing a stack of a fuel cell system according to the present invention.

### DETAILED DESCRIPTION OF THE ILLUSTRATED EMBODIMENTS

The present invention provides an inexpensive catalyst that improves fuel cells efficiency with its high level of activity. In addition, the mass activity, or the current density that can be obtained per unit mass of platinum, is also higher than conventional technologies.

The reduction reaction of oxygen at the cathode of a fuel cell is known as a rate determining step (rds). A detailed mechanism of the rds at a platinum surface has not yet been understood. However, it is generally believed that hydrogen strikes a platinum surface that has oxygen attached to it with sufficient force to cause the hydrogen to react with the attached oxygen. As a result, water is produced upon detachment of the oxygen from the platinum surface.

Conventionally, it has not been clearly known how the binding force between platinum and oxygen has an effect on and is related to the catalyst activity. However, it is known that the attachment strength of oxygen on the platinum surface is related to the reaction rate, which is closely related to a binding force between platinum and oxygen. With this understanding, the present invention regulates the electron arrangement of platinum for which the binding force between platinum and oxygen is sufficient. Thus, the catalyst activity can be optimized.

Various attachment models between platinum and oxygen have been presented, as shown below. In any model, it is understood that the binding force between platinum and oxygen affects the reaction mechanism.

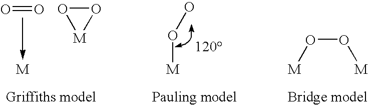

The catalyst of the present invention comprises an alloy of platinum and transition metals. In the stable electron arrangement of platinum, the D-band vacancy of the 5d-band orbital is more than 0.3 but not more than or equal to 0.45, more preferably at or between 0.34 and 0.41 and still more preferably at or between 0.34 and 0.36. When the vacancy is within these ranges, the catalyst activity is excellent.

The vacancy referred to in this present specification is a vacant site formed by a lack of an atom that should be at a lattice spot in a crystal. This vacancy is measured by using X-ray absorption spectroscopy (XAS). A D-band vacancy value, hⱼ, of the 5d-band orbital is obtained by Mathematical Formula 1 given below that takes into account the difference between dimensions of the first peak of a sample and that of a reference after measuring platinum with XAS (A. N. Mansour, J. R. Katzer, J. Catal., 1984, 89, 464).
Mathematical Formula 1: (h_{j,s})ₜₒₜₐₗ=(1.0+Fd)(h_{j,r})ₜₒₜₐₗ
where Fd=(ΔA₃+1.11ΔA₂)/(A₃+1.11A₂)R
where ΔA₂=(A₂ₛ−A₂ᵣ)
where ΔA₃=(A₃ₛ−A₃ᵣ)

A₂ and A₃ above are peak dimensions at L₂ and L₃ absorption edges, respectively, subscript s indicates the sample, subscript r indicates the reference, and R is the D-band vacancy of the reference. For a typical platinum catalyst, such as carbon supported platinum Pt/C, this reference D-band vacancy, is 0.3.

The d-band vacancy values depend on the binding force between the platinum atoms and the transition metal atoms if transition metals are alloyed. Therefore, in the present invention, the d-band vacancy was adjusted to a desired value by modifying the alloy composition during a metathesis process of the transition metals at the lattice structure of platinum. The d-band vacancy values can be altered by modifying the type of Pt/C, types of transition metal precursors, type and concentration of precursor solvents, alloy methods, temperatures, and times of heat treatment, gaseous condition, and so on.

A method of preparing the platinum and the transition metal alloy catalyst of the present invention will be explained.

First, platinum and a precursor of the transition metals are mixed. It is preferable to use a supported platinum because it may significantly decrease the quantity of platinum. Carbon materials such as acetylene black and graphite or fine particles of inorganic substances such as alumina, and silica, for example can be used as the support.

A commercially available supported platinum catalyst may be used, or it may be prepared. Methods for supporting platinum catalysts are widely known, so a detailed explanation thereof is omitted in the present specification.

Ni, Cr, Co, Fe, or a combination thereof for example, may preferably be used as the transition metal. Any type of compound such as halides, nitrates, hydrochlorides, sulphates, amine derivatives, etc. can be used as the transition metal precursors, of which halides are preferable.

Transition metal precursors are used in the liquid phase. Solvents such as water or alcohols including, but not limited to, methanol, ethanol, and propanol can be used to dissolve the transition metal precursors. The platinum and the transition metal precursors are preferably combined in a 1:1 to 3:1 molar ratio of the Pt to transition metal. If the molar ratio of the Pt:transition metal is not within the above range, the alloy process does not occur.

The platinum and transition metal precursor are preferably combined by dripping the liquefied transition metal precursor into the supported platinum drop by drop. After this mixing process, they are dispersed by ultrasonication. Then, the mixture is dried at about 110° C. for about one hour.

This mixture is then heat-treated at 500° C. to 1500° C., and more preferably at 700° C. to 1100° C. to form the platinum and transition metal alloy catalysts. If the temperature of the heat treatment is below 500° C., it becomes difficult to form the alloy. On the other hand, if the temperature is above 1500° C., the mixture evaporates as the temperature approaches the vaporization temperatures of the transition metals, thus altering the composition of the resulting catalyst. The heat treatment process may be performed in a reduction atmosphere comprising hydrogen gas, nitrogen gas, or a mixture of hydrogen and nitrogen.

The platinum and the transition metal alloy catalyst of the present invention can be used in fuel cells that use acids as electrolytes such as a phosphoric acid fuel cell, a polymer electrolyte membrane fuel cell, for example.

The fuel cell system of the present invention includes an electrolyte membrane, and a cathode and an anode on which catalytic layers of the present invention are formed. The cathode and anode are prepared by forming a catalytic layer on a carbon substrate such as a carbon paper, a carbon cloth, and a carbon non-woven fabric. The catalyst of the present invention can be used in both the anode and cathode, and is preferably used in the cathode. The carbon substrate has a gas diffusion layer that diffuses reaction gas into catalytic layers.

The anode and cathode disposed on both sides of the electrolyte membrane form is a membrane-electrode assembly, that make up a unit cell of the fuel cell system along with separators in which flow channels for fuel and oxygen are provided. A stack includes at least one unit cell. The fuel cell system is assembled by connecting the stack to a fuel supply source and an oxygen supply source.

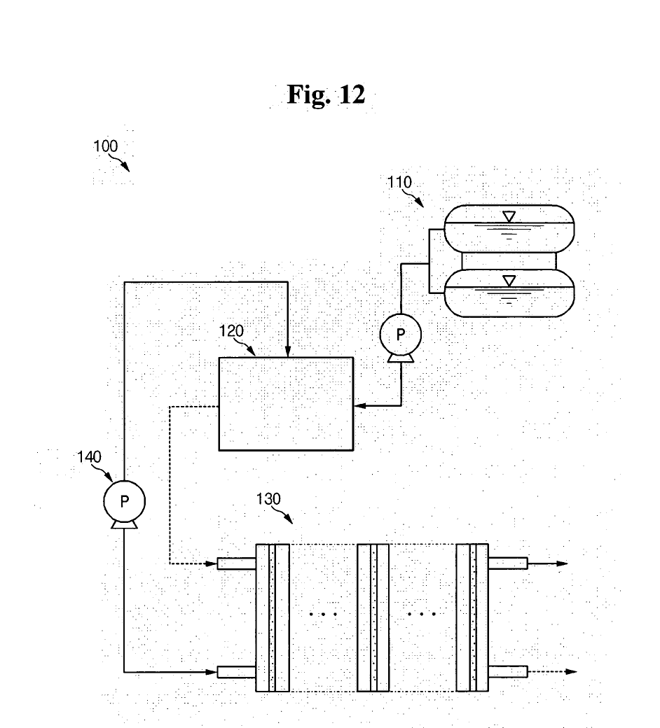

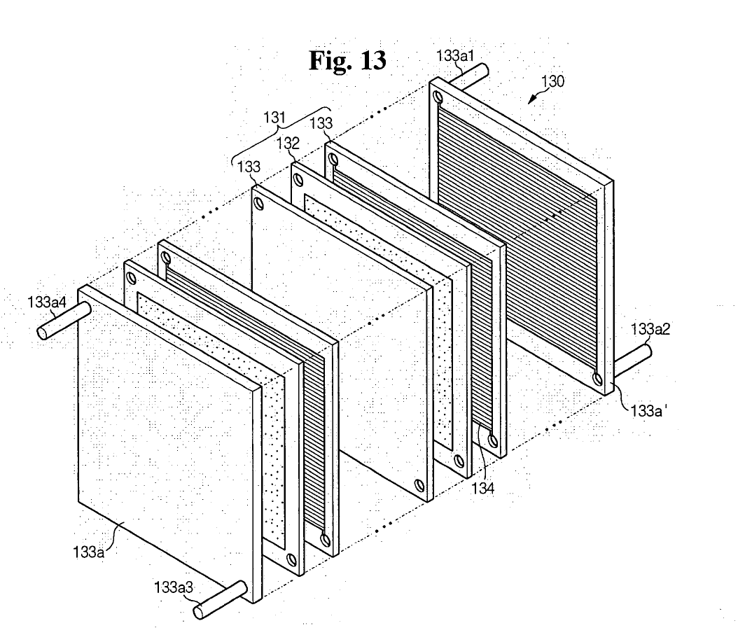

FIG. 12 is a schematic view showing a fuel cell system 100 of the present invention, and FIG. 13 is an exploded perspective view showing a stack 130 of FIG. 12.

Referring to FIGS. 12 and 13, a fuel cell system 100 of the present invention includes a fuel supplying part 110 that supplies fuel mixed with water and a reforming part 120 that converts the mixed fuel to generate hydrogen. It also includes a stack 130 that includes a catalyst that aids in the chemical reaction between the hydrogen gas supplied from the reforming part and external air. In addition, the fuel cell system has an air supplying part 140 that supplies external air to the reforming part 120 and the stack 130.

Furthermore, the fuel cell system 100 of the present invention may include a plurality of unit cells 131 that induce an oxidation-reduction reaction between the hydrogen gas supplied from the reforming part 120 and the external air supplied from the air supplying part 140 to generate electric energy.

Each unit cell serves as a unit for generating electricity, including a membrane-electrode assembly 132 that oxidizes and reduces hydrogen and oxygen in air, respectively, and separators 133 that supply the hydrogen and air to the membrane-electrode assembly 132. The separators 133 are arranged on both sides of the membrane-electrode assembly 132. The separators at the most exterior sides of the stack are referred to as end plates 133a, 133a′.

The membrane-electrode assembly 132 includes an anode and a cathode that are formed on one side of the assembly and have an electrolyte membrane between them. The anode that is supplied with hydrogen gas through the separator 133 includes a catalytic layer that converts the hydrogen gas into electrons and hydrogen ions by an oxidation reaction. It also includes a gas diffusion layer that moves the electrons and hydrogen ions smoothly.

The cathode that is supplied with air through the separator 133 includes a catalytic layer that converts oxygen in air into electrons and oxygen ions via reduction reaction. It also includes a gas diffusion layer that moves the electrons and oxygen ions smoothly. The electrolyte membrane is a solid polymer electrolyte that serves as an ion exchanging membrane that moves the hydrogen ions generated from the anode's catalytic layer to the cathode's catalytic layer.

Moreover, an end plate 133a′ of the separators includes a pipe-shaped first supply tube 133a1 for injecting the hydrogen gas supplied from the reforming part, and a pipe-shaped second supply tube 133a2 for injecting the oxygen gas. The other end plate 133a includes a first discharge tube 133a3 for discharging the unreacted hydrogen gas to the outside, and a second discharge tube 133a4 for discharging the unreacted air to the outside.

The fuel cell system of the present invention is not limited as shown in FIGS. 12 and 13.

Hereinafter, preferred examples and comparative examples will illustrate the present invention. However, it is understood that the examples are for illustration only, and that the present invention is not limited to these examples.

### EXAMPLE 1

A NiCl₂ (Aldrich, dehydrated, purity 99%) aqueous solution was incorporated with a commercially available platinum catalyst (Pt/C) supported on a carbon support (Johnson Matthey Co. 10 wt. % platinum based on weight of carbon support). At this time, the molar ratio of Pt:Ni was 3:1. The incorporated product was heat-treated at 700° C., and an alloy of Pt—Ni on a carbon support (Pt—Ni/C) was produced.

### EXAMPLE 2

A Pt—Ni/C was prepared in the same way as in Example 1 except that the heat treatment was performed at 900° C.

### EXAMPLE 3

A Pt—Ni/C was prepared in the same way as in Example 1 except that the heat treatment was performed at 1100° C.

### COMPARATIVE EXAMPLE 1

The commercially available Pt/C catalyst (Johnson Matthey Co. 10 wt %) was used.

The catalysts of Examples 1 to 3 and Comparative Example 1 had particle sizes of about 30 to 150 Å.

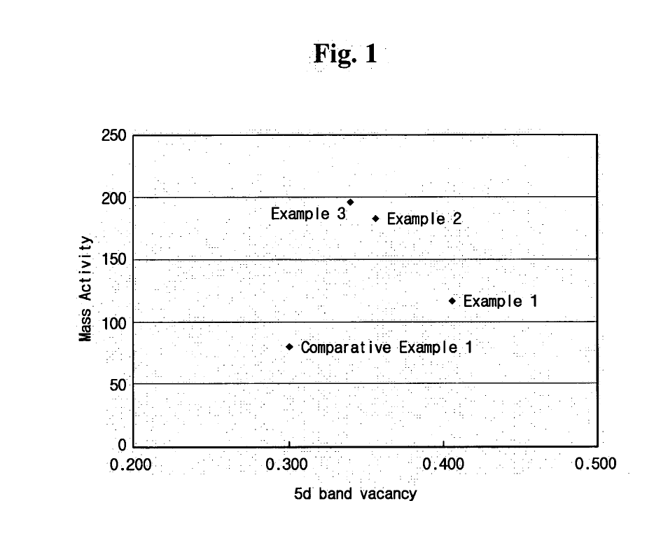

After preparing an electrode by adhering the catalysts produced according to Examples 1 to 3 and Comparative Example 1 to a non-woven carbon fabric by a rolling method, the current density (mass activity) at 900 mV with regard to the hydrogen standard electrode was measured using a half electric cell. The results are shown in the below Table 1 and FIG. 1. In Table 1, the mass activity (A/g of Pt) refers to the current values obtained by the half electric cell tests divided by the catalyst (Pt—Ni) mass. The D-band vacancy of the 5d-band orbital of the catalysts produced according to Examples 1 to 3 and Comparative Example 1 were measured with XAS, and the results are also indicated in Table 1 and FIG. 1.

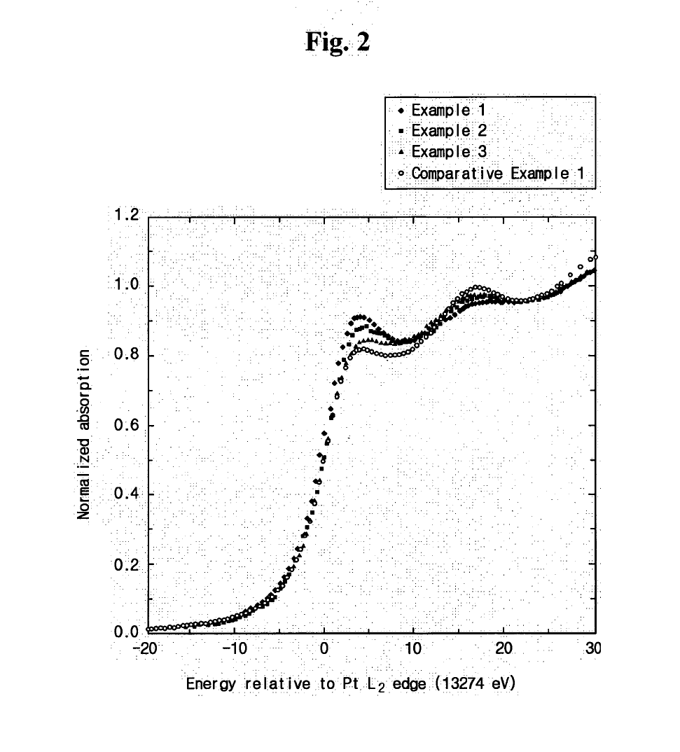

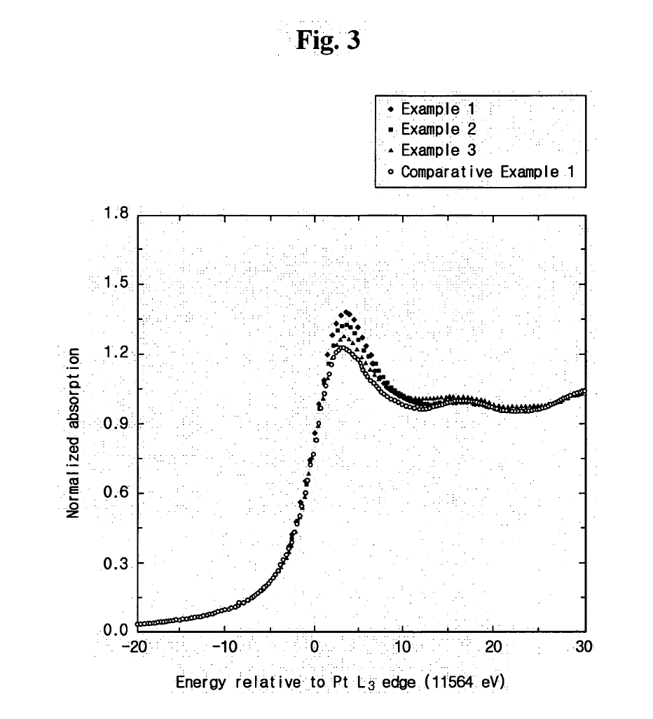

Then, the spectra shown in FIG. 2 (L₂ edge) and FIG. 3 (L₃ edge) were obtained. At this time, differences between dimensions of the first peaks of the samples and dimensions of the reference were obtained by Mathematical Formula 1. With regard to L₂ and L₃, L refers to an electron shell for which the main proton number in an atomic orbital is 2. Moreover, after more dividing of the L electron shell by an orbital unit, it is expressed as the forms shown by L₁, L₂, L₃ from the inside. As a result, the L₂ and L₃ refer to the second and the third sub-shells of the L electron shell.

TABLE 1

| | | D-band vacancy | Mass activity (A/g) |
|---|---|---|---|
| Comparative | Pt/C | 0.300 | 80.1 |
| Example 1 | | | |
| Example 1 | Pt3/Ni (700° C.) | 0.406 | 116 |
| Example 2 | Pt3/Ni (900° C.) | 0.356 | 182 |
| Example 3 | Pt3/Ni (1100° C.) | 0.340 | 196 |

As demonstrated in Table 1 and FIG. 1, the catalysts of Examples 1 to 3 have superior mass activities to that of Comparative Example 1. Particularly, the catalysts of Examples 2 to 3 demonstrate excellent activity that is nearly double of the mass activity of Comparative Example 1.

### EXAMPLE 4

A Pt—Ni/C catalyst was prepared in the same way as in Example 1 except that the molar ratio of Pt:Ni was changed to 1:1.

### EXAMPLE 5

A Pt—Ni/catalyst was prepared in the same way as in Example 2 except that the molar ratio of Pt:Ni was changed to 1:1.

### EXAMPLE 6

A Pt—Ni/C catalyst was prepared in the same way as in Example 3 except that the molar ratio of Pt:Ni was changed to 1:1.

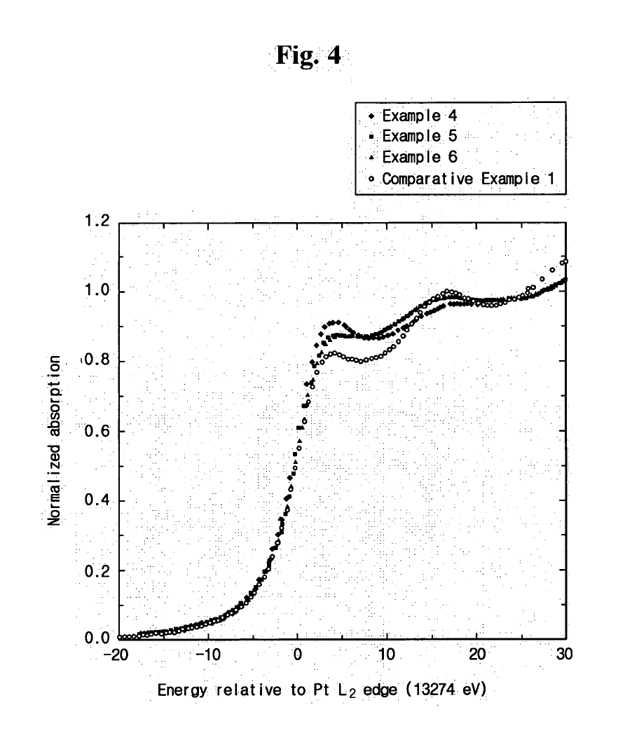

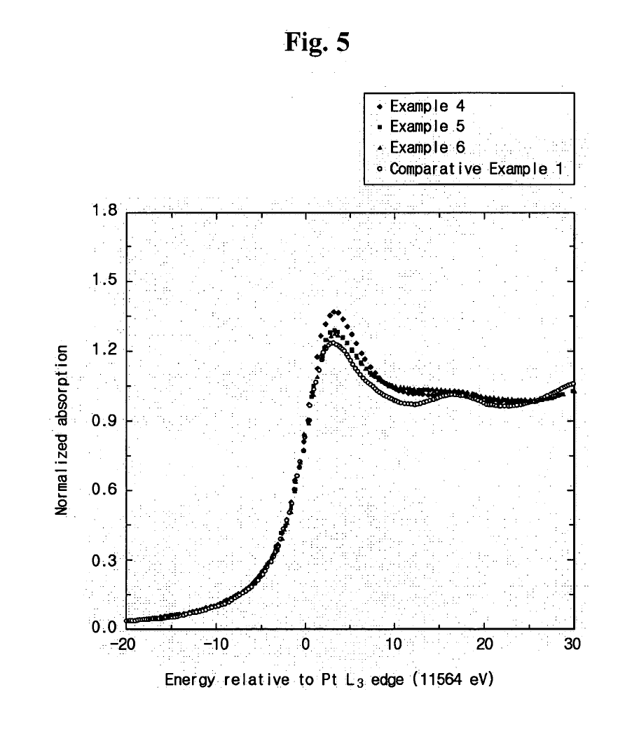

The catalysts prepared in Examples 4 to 6 and Comparative Example 1 were measured with XAS, and the results are shown in FIG. 4 (L₂ edge) and FIG. 5 (L₃ edge). Since the measured results are to be similar to the ones shown in FIG. 1, it is evident that the catalysts of Examples 4 to 6 have excellent mass activities.

### EXAMPLE 7

A Pt—Ni/C catalyst was prepared in the same way as in Example 3 except that the transition metal was changed to Co instead of Ni.

### EXAMPLE 8

A Pt—Ni/C catalyst was prepared in the same way as in Example 3 except that the transition metal was changed to Cr instead of Ni.

### EXAMPLE 9

A Pt—Ni/C catalyst was prepared in the same way as in Example 2 except that the transition metal was changed to Fe instead of Ni.

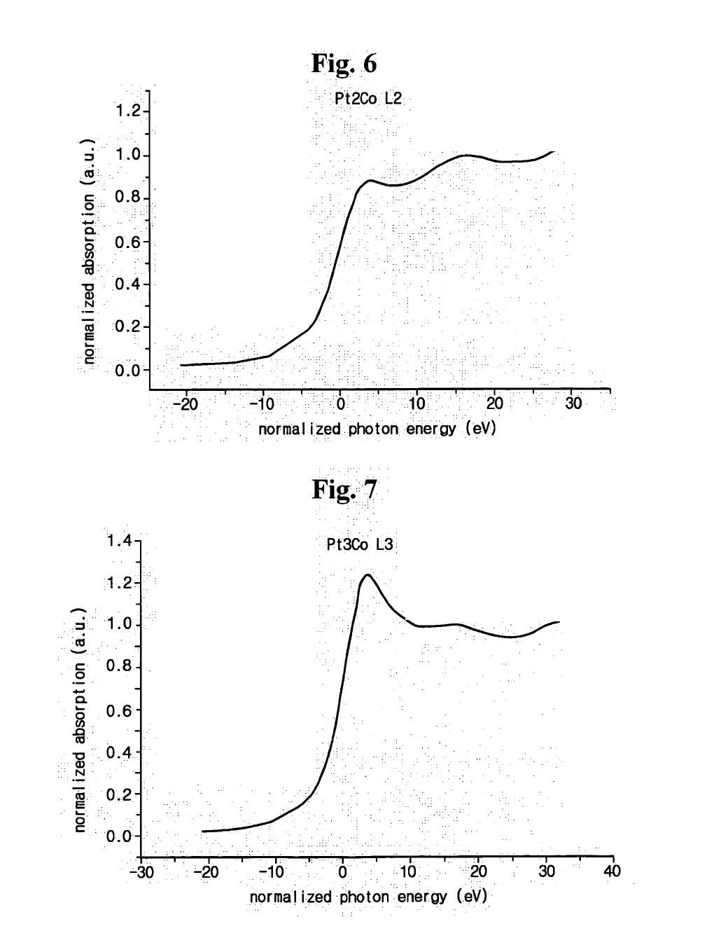

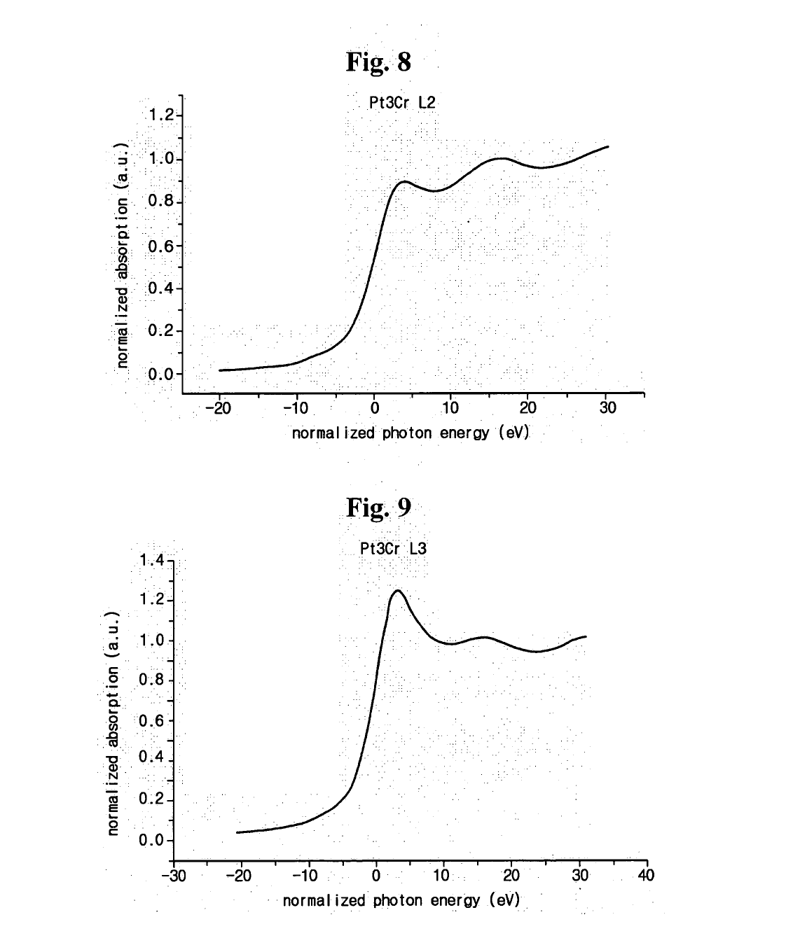

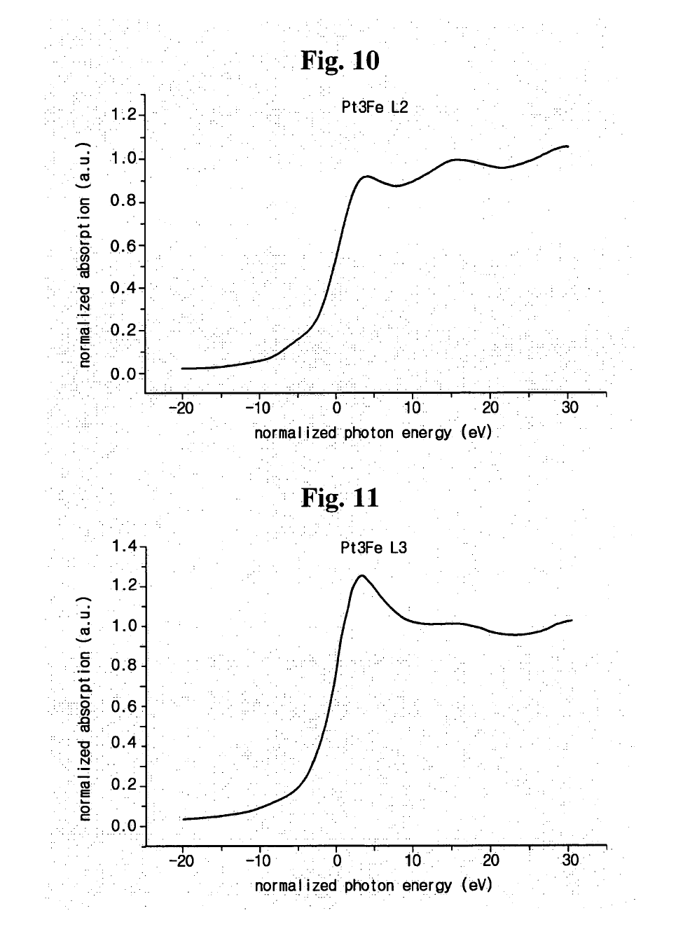

The catalyst prepared in Example 7 was measured with XAS, and the results are shown in FIG. 6 (L₂ edge) and FIG. 7 (L₃ edge). The catalyst prepared in Example 8 was measured with XAS, and the results are shown in FIG. 8 (L₂ edge) and FIG. 9 (L₃ edge). The catalyst prepared in Example 9 was measured with XAS, and the results are shown in FIG. 10 (L₂ edge) and FIG. 11 (L₃ edge). Since the measured results are similar to the ones shown in FIG. 1, it is evident that the catalysts of Examples 7 to 9 also have excellent mass activities.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A membrane-electrode assembly comprising a catalytic layer arranged a side of a polymer electrolyte membrane,
wherein the catalytic layer comprises a platinum and transition metal alloy catalyst, and
wherein a D-band vacancy of a 5d-band orbital of the platinum in the platinum and transition metal alloy catalyst is more than 0.3 but not more than or equal to 0.45.

2. The membrane-electrode assembly of claim 1, wherein a D-band vacancy of a 5d-band orbital of the platinum is in a range of at or between 0.34 and 0.41.

3. The membrane-electrode assembly of claim 1, wherein the transition metal is selected from the group consisting of Ni, Cr, Co, Fe and a combination thereof.

4. The membrane-electrode assembly of claim 1, wherein the alloy catalyst is prepared by mixing the platinum and transition metal precursors in a molar ratio of platinum to transition metals that is between 1:1 to 3:1 and then heat-treating the mixture at 700 to 1100° C.

5. The membrane-electrode assembly of claim 4, wherein the platinum is supported.

6. A fuel cell system, comprising:
a polymer electrolyte membrane;
a membrane-electrode assembly including a cathode and an anode that are coated by a catalytic layer and are each arranged on a side of the polymer electrolyte membrane; and
separators,
wherein the catalytic layer comprises a platinum and transition metal alloy catalyst, and
a D-band vacancy of a 5d-band orbital of the platinum in the platinum and transition metal alloy catalyst is more than 0.3 but not more than or equal to 0.45.

7. The fuel cell system of claim 6, wherein a D-band vacancy of a 5d-band orbital of platinum is in a range of at or between 0.34 and 0.41.

8. The fuel cell system of claim 6, wherein the transition metal is selected from the group consisting of Ni, Cr, Co, Fe and a combination thereof.

9. The fuel cell system of claim 6, wherein the alloy catalyst is prepared by mixing the platinum and transition metals precursors in a molar ratio of platinum to transition metals that is between 1:1 to 3:1 and heat-treating the mixture at 700 to 1100° C.

10. The membrane-electrode assembly for a fuel cell of claim 9, wherein the platinum is supported.
